(19) United States
(12) Patent Application Publication
(10) Pub. No.: US 2007/0251684 A1
(43) Pub. Date: Nov. 1, 2007

(54) Watertube and Method of Making and Assembling Same within a Boiler or Heat Exchanger

(75) Inventors: Edward A. Bender, Peru, IN (US); Thomas W. Moore, Bunker Hill, IN (US)

Correspondence Address: HOWSON AND HOWSON, SUITE 210, 501 OFFICE CENTER DRIVE, FT WASHINGTON, PA, 19034, US

(73) Assignee: Burnham Services, Inc., Wilmington, DE (US)

(21) Appl. No.: 11/380,456

(22) Filed: Apr. 27, 2006

(51) Int. Cl. F28F 9/04; F16L 23/00

(52) U.S. Cl. 165/178; 285/405

(57) ABSTRACT

A one-piece tube for use as a watertube within a watertube boiler or heat exchanger has a free end section that is formed to have an integral, outward-extending circumferential ring, or flange, a spaced distance from an adjacent end face of the tube. This is preferably accomplished by radially expanding the tube within the free end section and by axially compressing the free end section to cause a portion of the tube to bulge radially outward to from the circumferential ring, or flange. The flange enables the watertube to be readily driven into engagement with a dome, manifold or like casting without the creation of leaks, such as weld leaks. The free end section of the tube that extends from the circumferential ring, or flange, to the adjacent end face of the tube can be formed with a taper such that the diameter of an outer wall of the tube progressively decreases from the circumferential ring, or flange, to the end face. A boiler or heat exchanger having the above described watertube and a method of assembly are also provided.

### BACKGROUND OF THE INVENTION

The present invention relates to a boiler and/or heat exchanger used in a domestic and/or commercial heating and/or hot water and/or steam system, and more specifically, the present invention relates to a watertube structure and to methods of making a watertube and assembling it within a boiler and/or similar heat exchanger.

Examples of boilers having watertubes are provided by U.S. Pat. No. 1,824,256 issued to Bryan and U.S. Pat. No. 4,993,368 issued to Jones et al. For example, the Bryan patent discloses a boiler having a plurality of bent watertubes extending through a combustion chamber. The ends of the bent watertubes connect to the upper and lower domes of the boiler via separately manufactured tapered fittings.

A conventional watertube for a boiler and/or heat exchanger is typically made of a metallic material and has substantially constant inner and outer diameters from end-to-end. The tubes extend in various bent, serpentine, or other shapes or patterns between opposite free ends. A separately-manufactured tapered fitting is typically welded to each free end to enable the tubes to be connected in a fluid-tight and secure manner to domes, manifolds, and like castings.

The separately-manufactured fitting typically provides the end of the tube with an outwardly-extending circumferential ring and a tapered end section. The tapered end section is inserted into a corresponding tapered hole, port or socket in a dome, manifold, or like casting. A clip, clasp or like fastener is typically applied to the circumferential ring to ensure that the inserted tube end remains in engagement with the dome, manifold, or like casting.

A 45° angle fillet weld is typically used to connect the fitting to the tube. The 45° angle fillet weld extends from an upper, exposed, radially-extending end surface of the circumferential ring to the adjacent outer wall surface of the tube. A problem with the use of the fillet weld is that the fillet weld eliminates any clean or flat surface of the circumferential flange on which a force can be readily applied to drive the tube end into the hole in a dome or the like. Existence of the fillet weld further complicates the already difficult and inefficient process of handling relatively heavy tubes within small spaces available during a boiler or heat exchanger assembly and the process of driving the tube ends into position within the boiler in a manner that provides leak-free connections.

Accordingly, there is a need for a watertube structure that can be handled and driven more easily into a hole, port or socket of a dome, manifold, or casting to create a leak-free connection therewith. In addition, there is a need for an efficient process of assembling watertubes in boilers and heat exchangers and for making watertubes.

### BRIEF SUMMARY OF THE INVENTION

According to a first aspect of the present invention, a method of making a tube for a boiler or heat exchanger is provided. A one-piece tube for use as a watertube within a boiler or heat exchanger has a free end section of a predetermined substantially-constant diameter. The method includes the step of forming an integral, outward-extending circumferential ring, or flange, on the free end section of the tube a spaced distance from an adjacent end face of the tube. This may be accomplished by radially expanding the tube within the free end section followed by axially compressing the free end section to cause a portion of the tube to bulge radially outward to form the circumferential ring or flange. The method can also include the step of forming the free end section of the tube that extends from the circumferential ring, or flange, to the adjacent end face of the tube with a taper such that the diameter of an outer wall of the tube progressively decreases from the circumferential ring, or flange, to the end face. Preferably, the tube is made of a metallic material and the forming process is cold or hot forming process.

According to another aspect of the present invention, a method of assembling a watertube boiler or heat exchanger is provided. A one-piece metallic tube having a free end section of a predetermined substantially-constant diameter is cold and/or hot-formed to produce an integral circumferential flange extending outwardly from the tube a spaced distance from an adjacent end face of the tube. A force is applied on a radially-extending surface of the circumferential flange to drive the end of the metallic tube into a hole, port or socket of a dome, manifold or like casting of a watertube boiler or heat exchanger to secure the one-piece tube to the dome, manifold or like casting. Before being engaged with the dome, manifold or like casting, the free end section of the metallic tube that extends from the circumferential flange to the adjacent end face can be formed with a taper such that the diameter of an outer wall of the tube progressively decreases from the circumferential flange to the end face.

According to yet another aspect of the present invention, a boiler or heat exchanger is provided. The boiler or heat exchanger has at least a pair of opposed domes, manifolds, or like castings and one or more metallic watertubes each having opposite ends connected to the opposed domes, manifolds, or like castings. At least one end section of the one-piece watertube is formed to have an integral outwardly-extending circumferential flange. The flange provides a readily-engagable, radially-extending surface on which a substantially axially-directed force can be applied to drive the end of the tube into sealing engagement with a hole, port, or socket of one of the domes, manifolds, or like castings. Preferably, a portion of the tube extending from the circumferential flange to an adjacent end face of the tube is formed with an inward taper such that a diameter of an outer wall of the tube progressively decreases from the circumferential flange to the end face. A wall defining the hole, port, or socket in the dome, manifold or like casting can be tapered to enable tight engagement with the tapered end of the tube. The watertube can have a substantially serpentine shape between its opposite ends.

### BRIEF DESCRIPTION OF THE DRAWINGS

The features and advantages of the present invention should become apparent from the following description when taken in conjunction with the accompanying drawings, in which:

FIG. 1 is a cross-sectional view of a watertube boiler according to the above referenced prior art Bryan patent;

FIG. 2 is a schematic view of a tube expansion method step according to the present invention;

FIG. 3 is a cross-sectional view taken along line 3-3 of FIG. 2;

FIG. 4 is a schematic view of a ring, or flange, forming step according to the present invention;

FIG. 5 is a cross-sectional view taken along line 5-5 of FIG. 4;

FIG. 6 is a schematic view of a taper forming step according to the present invention;

FIG. 7 is a cross-sectional view taken along line 7-7 of FIG. 6;

FIG. 8 is a perspective view of an end section of a formed watertube according to the present invention; and

FIG. 9 is a cross-sectional view taken along line 9-9 of FIG. 8.

### DETAILED DESCRIPTION OF THE INVENTION

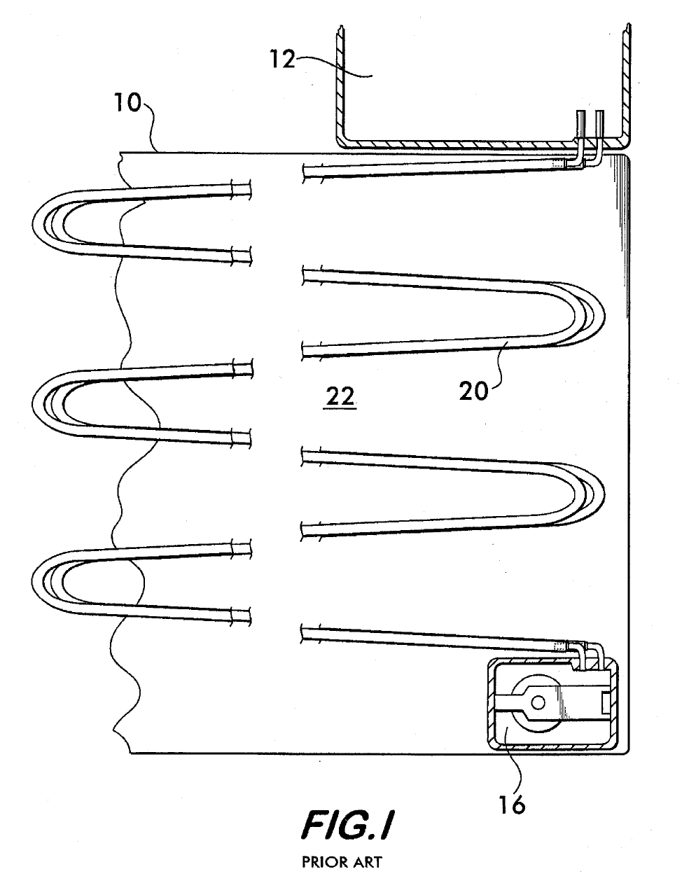

The present invention relates to watertubes that are used in commercial boilers, heat exchangers, and like apparatus. FIG. 1 illustrates an example of a watertube boiler 10 that is known in the art. The boiler 10 includes at least one upper dome 12 and at least one base header 16. The so-called bent watertubes 20 have opposite ends interconnecting the base header 16 to the dome 12. A serpentine portion of each watertube 20 extends within a combustion chamber 22 of the boiler. System water is fed into the boiler 10 or dome 12 and travels within the watertubes 20. The water is heated in the watertubes 20 and the heated water or steam flows from the watertubes 20 into the dome 12 and then to a system supply pipe.

A typical watertube is made of a metallic material. The inner and outer diameters of such a watertube are typically constant from end-to-end. For example, the outer diameter of each tube may be 1.5 inch, and the inner diameter of each tube may be 1.25 inch thereby providing a tube wall thickness of about 0.125 inch. The watertubes can extend in serpentine or other shaped paths including linear shaped paths. The watertubes are assembled within boilers, heat exchangers and like apparatus.

A watertube 30 according to the present invention is similar to watertube 20 discussed above; however, the watertube 30 is provided as one-piece without the use of separately-manufactured fittings, nipples, or like coupling devices secured or welded thereto. Rather, the watertube 30 according to the present invention has a free end section that is formed into a desired shape without any component being added or welded thereto. Accordingly, there are no fillet welds or the like capable of providing leakage paths.

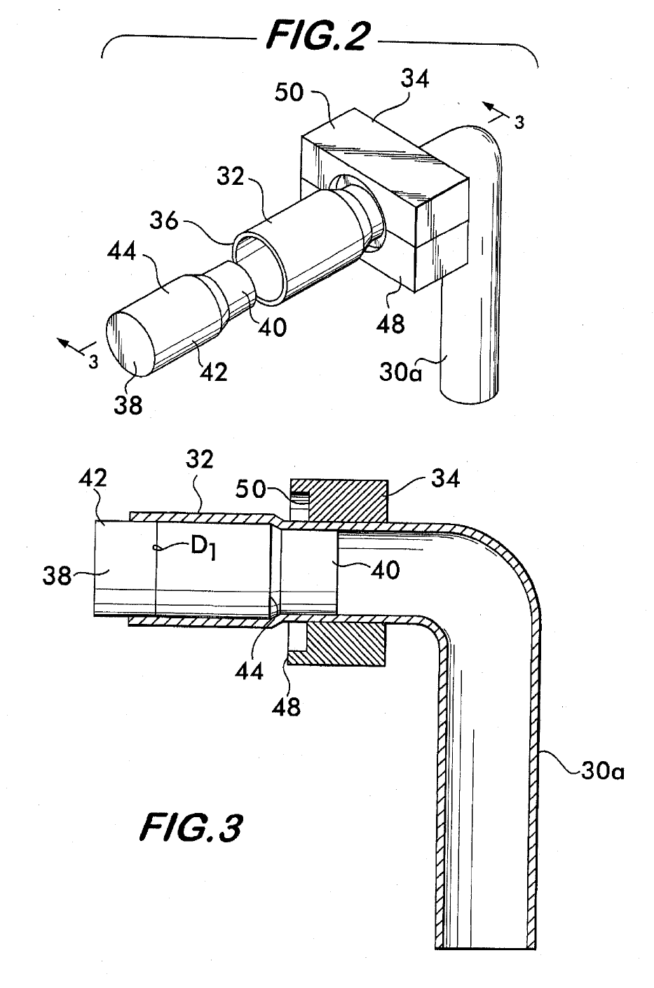

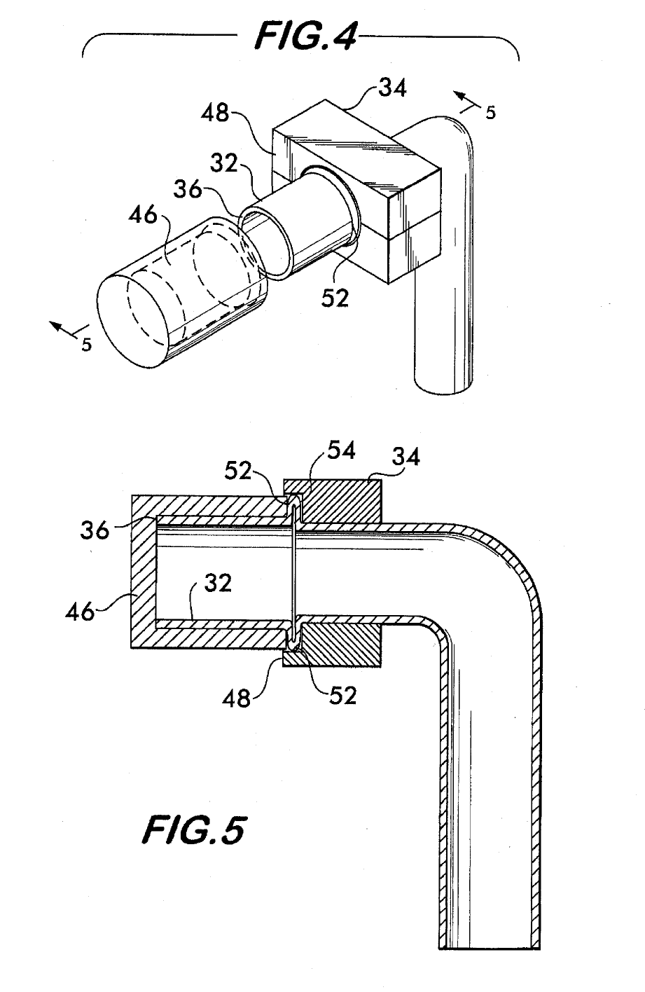

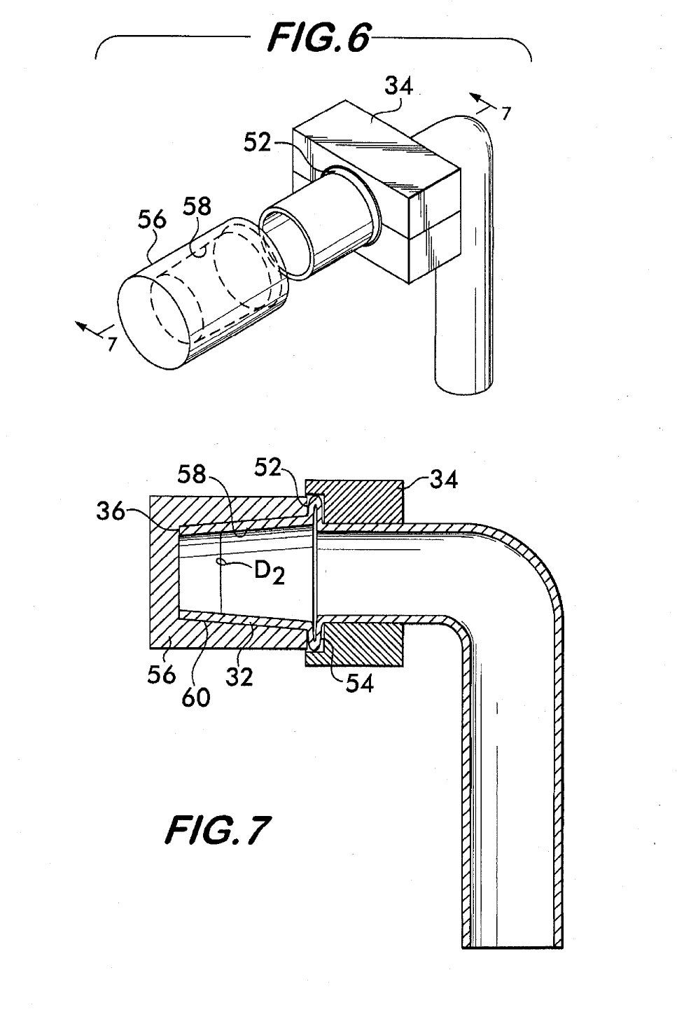

The method of making the watertube 30 is shown in FIGS. 2-7. A tube 30a is initially provided having an end section 32 with a uniform and constant inner diameter and a uniform and constant outer diameter. A holding clamp 34 is positioned about a portion of the tube to grip the tube a predetermined spaced distance from an adjacent end face 36 of the tube 30a. The holding clamp 34 rigidly supports the tube relative to one or more dies 38 that are capable of being inserted into the end section 32 to radially expand the end section 32.

The die 38 shown in FIGS. 2 and 3 includes a tip 40 of a diameter sufficiently small to permit insertion within the tube 30a without resistance. An opposite end of the die 38 includes an expansion section 42 that is larger in diameter than the inner diameter of the tube 30. The die 38 also includes an intermediate frustoconical section 44 that transitions the diameter of the die 38 from that of the tip 40 to that of the expansion section 42. Accordingly, the outer and inner diameters of the tube 30 can be radially expanded by inserting the die 38 therein with a predetermined amount of force, and/or by sequentially inserting a set of dies each having a progressively larger diameter expansion section. Thus, end section 32 can be expanded to a desired inner diameter D1.

After the end section 32 is expanded, an upsetting element 46 or the like engages the end face 36 and applies an axially directed force thereon to thereby compress the axial length of the end section 32. The upsetting element 46 can include an insertable support section (not shown) that extends within the end section 32 of the tube 30 while the upsetting element 46 applies the desired axial force. A face 48 of the holding clamp 34 has an annular recessed molding area 50 into which the end section 32 bulges in response to the axial compression. This results in the formation of an integral, radially outward extending, circumferential ring, or flange, 52. Preferably, the flange 52 includes a radially-extending, substantially-flat surface 54 that is located on a distal side of the flange 52 and that is readily engagable by a forked or like driving tool (not shown) for reasons discussed in greater detail below.

After the end section 32 is radially expanded and axially compressed, one or more dies 56 is utilized to provide the end section 32 with an outer diameter D2 that tapers inward from the flange 52 to the end face 36. For example, the die 56 can have a tapered inner surface 58 that is telescopically forced over the end section 32 to thereby radially contract the outer and inner diameters of the end section 32. In this way, the die 56, or a set of dies, can be used to provide the end section 32 with a frustoconical, or gradually tapered, outer wall 60.

As stated above, the tube 30 can be made of metallic material, for example steel. Of course, watertubes made of other materials can also be used. Preferably, the forming steps are cold and/or hot-forming steps without the use of any stress-relieving process steps, and both ends of the tube 30 can be formed as described above. Accordingly, the watertube 30 is a one-piece tube without separately-manufactured fittings or nipples and without welded connections.

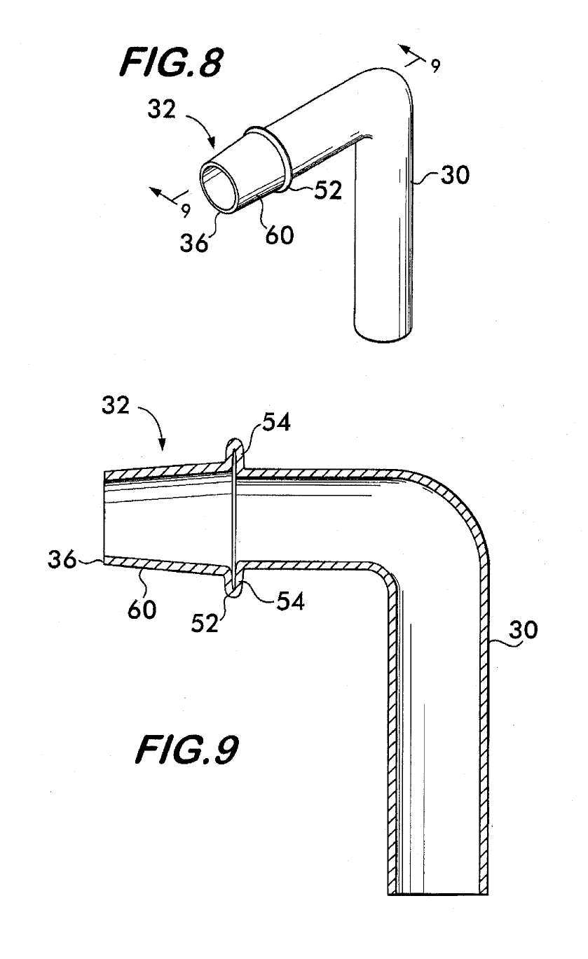

The watertube 30 having a formed end section 32 as shown in FIGS. 8 and 9 can be assembled in a boiler, heat exchanger, or like apparatus. Preferably, the boiler, heat exchanger, or like apparatus has one or more pairs of opposed domes, headers, manifolds, or like castings. These castings preferably have a tapered hole, port or socket for receiving and engaging a tapered end section 32 of the watertube 30. Accordingly, the end section 32 is aligned with the hole, port or socket and a force is applied to drive the watertube into fluid-tight engagement with the dome, manifold or like casting. For examples of boilers, domes, manifolds and the like, the disclosures of U.S. Pat. Nos. 1,824,256 and 4,993,368 are incorporated herein by reference.

A forked tool (not shown) or the like is utilized to engage the unobstructed, radially extending surface 54 of the circumferential flange 52 and exert a substantially axially directed force thereon to efficiently drive the tapered end section 32 into the hole, port, or socket. Thereafter, a clip, clasp or like fastener can be placed over the flange 52 to ensure that it remains engaged with the dome, manifold or like casting.

The above described methods, boiler, heat exchanger and like apparatus provide watertubes that can be driven more efficiently and more easily into domes, manifolds and the like. The use of separate fittings and welds are eliminated thereby eliminating the possibility of weld leaks and the like. In addition, a driving force can be applied to the tube during the assembly process without concern of creating leakage paths. The end forming process also enables better control over tube tolerances with respect to diameters, tapers and the like to further ensure the formation of fluid-tight connections.

Various changes can be made to the above referenced methods and apparatus. For example, the circumferential flange 52 can be continuous or discontinuous, and the flange surface 54 can be of shapes other than substantially-flat. For example, the flange can be formed with a surface having a series of slots, recesses, or the like adapted to engage the head of a driving tool. One or both ends of the tube can have a formed end, and the tube can extend in a bent or linear path. The taper of the end section can be a gradually continuous uniform taper or a non-uniform varying taper. Alternatively, a uniform, non-tapered end section can be utilized.

While preferred methods and apparatus have been described in detail, various modifications, alterations, and changes may be made to the present invention without departing from the spirit and scope of the present invention as defined in the appended claims.

1. A method of making a tube for a boiler or heat exchanger, comprising the steps of:
providing a tube for use as a watertube within a watertube boiler or heat exchanger, the tube having a free end section of a predetermined substantially-constant outer diameter; and
forming the free end section of the tube with an integral circumferential flange extending radially outward from the tube a spaced distance from an adjacent end face of the tube.

2. A method according to claim 1, wherein the tube is made of metallic material.

3. A method according to claim 2, wherein said forming step is a cold and/or hot-forming step.

4. A method according to claim 3, further comprising the step of forming the free end section of the tube that extends from the circumferential flange to the adjacent end face with a taper such that the outer diameter of the tube progressively decreases from the circumferential flange to the end face.

5. A method according to claim 3, wherein said forming step includes a step of clamping a holding clamp about the free end section of the tube.

6. A method according to claim 5, wherein said forming step includes a step of expanding an inner diameter of the free end section of the tube, after said clamping step, by inserting at least one die into the free end section of the tube.

7. A method according to claim 6, wherein said forming step includes a step of applying a force on the end face of the tube, after said expanding step, to axially compress the free end section of the tube and cause the tube to bulge outwardly thereby creating the circumferential flange.

8. A method according to claim 7, wherein said forming step includes the step of reducing the outer diameter of the free end section that extends from the circumferential flange to the adjacent end face, after said applying step, by inserting the free end section of the tube into at least one die so that the outer diameter of the tube progressively decreases from the circumferential flange to the end face.

9. A method according to claim 8, wherein the tube is a bent watertube, and wherein the circumferential flange provides an engagable surface to which a force can be applied to drive the tube into a receiving hole in a dome, manifold or the like casting of the boiler or heat exchanger.

10. A method of assembling a watertube boiler or heat exchanger, comprising the steps of:
providing a one-piece metallic tube having a free end section of a predetermined substantially-constant outer diameter;
cold and/or hot-forming the free end section of the tube to provide an integral circumferential flange extending radially outward from the tube a spaced distance from an adjacent end face of the tube; and
after said forming step, applying a force on a surface of the circumferential flange to drive the free end section of the tube into a dome, manifold, or like casting of a watertube boiler or heat exchanger to secure the one-piece tube thereto.

11. A method according to claim 10, wherein, after the free end section of the tube is received in the dome, manifold or like casting, a securement clip, clasp or like fastener is engaged to the surface of the circumferential flange to further secure the one-piece tube to the dome, manifold, or like casting.

12. A method according to claim 10, wherein an opposite free end of the one-piece tube is formed with an integral circumferential flange and is secured to an oppositely located dome, manifold, or like casting.

13. A method according to claim 10, wherein said forming step includes forming the free end section of the tube that extends from the circumferential flange to the adjacent end face of the tube with a taper such that the outer diameter of the tube progressively decreases from the circumferential flange to the end face.

14. A method according to claim 10, wherein, during said forming step, the free end section of the tube is secured in a holding clamp.

15. A method according to claim 14, wherein, during said forming step, an inner diameter of the free end section of the tube is expanded by inserting at least one die into the free end section of the tube.

16. A method according to claim 15, wherein, during said forming step, a force is applied on the free end section of the tube to axially compress the free end section and form the outwardly-extending circumferential flange.

17. A method according to claim 16, wherein, during said forming step, the outer diameter of the free end section of the tube is reduced by inserting the free end section into at least one die to provide the free end section with an inward taper from the circumferential flange to the adjacent end face.

18. A method according to claim 17, wherein said tube is a watertube that has a serpentine shape.

19. A boiler or heat exchanger, comprising:
at least a pair of opposed domes, manifolds, or like castings; and
at least one metallic watertube having opposite end sections connected to said opposed domes, manifolds, or like castings;
at least one of said end sections of said watertube being formed with an integral outwardly-extending circumferential flange providing a drivable surface for use in forcing said one end section into engagement with a receiving port in one of said water domes, manifolds, or like castings.

20. A boiler or heat exchanger according to claim 19, wherein a portion of said end section of said watertube extending from said circumferential flange to an adjacent end face of said watertube is inwardly tapered such that an outer diameter of said watertube progressively decreases from said circumferential flange to said end face.

21. A boiler or heat exchanger according to claim 20, wherein said watertube has a substantially serpentine shape between said opposite end sections.
